(19) United States
(12) Patent Application Publication
(10) Pub. No.: US 2014/0278673 A1
(43) Pub. Date: Sep. 18, 2014

(54) MEETING SCHEDULING APPLICATION

(71) Applicants: Robert Wetzold, Heidelberg (DE); Martin Pospischil, Heidelberg (DE)

(72) Inventors: Robert Wetzold, Heidelberg (DE); Martin Pospischil, Heidelberg (DE)

(73) Assignee: SAP AG, Walldorf (DE)

(21) Appl. No.: 13/830,783

(22) Filed: Mar. 14, 2013

(51) Int. Cl. G06Q 10/10

(52) U.S. Cl. CPC G06Q 10/1093
USPC 705/7.19

(57) ABSTRACT

A lunch networking system identifies participants of a meeting scheduling program in an organization. The system determines the availability schedules of participants of the meeting scheduling program. The availability schedules are selected by the corresponding participants. Participants are matched based on the corresponding availability schedules and location. An invitation is generated to the matched participants.

### FIELD

The present disclosure relates generally to a business networking tool, and in a specific example embodiment, to a meeting scheduling application.

### BACKGROUND

Meetings with colleagues for activities or lunches within an organization promote cross-communication of ideas that can potentially enhance the productivity of employees by sharing knowledge and contributing to the success of the organization. However, scheduling such meetings with colleagues within an organization can be a cumbersome and tedious process because it requires the active step of identifying a colleague, determining a mutually agreeable date, and actively sending out an invitation to the identified colleague. For example, a newly recruited employee of an organization may be reluctant to initiate an invitation to meet for lunch with other colleagues that he or she has not met before.

As such, many individuals may decide to have lunch on their own or with the same colleagues without reaching out to others within an organization.

### BRIEF DESCRIPTION OF DRAWINGS

The appended drawings merely illustrate example embodiments of the present invention and cannot be considered as limiting its scope.

FIG. 1A is a block diagram illustrating an example of a system in which embodiments may be practiced.

FIG. 1B is a block diagram illustrating another example of a system in which embodiments may be practiced.

FIG. 2 is a block diagram illustrating an example embodiment of a meeting scheduling application.

FIG. 3 is a block diagram illustrating an example embodiment of an identity management module of the meeting scheduling application of FIG. 2.

FIG. 4 is a block diagram illustrating an example embodiment of a schedule module of the meeting scheduling application of FIG. 2.

FIG. 5 is a block diagram illustrating an example embodiment of a filter preferences module of the meeting scheduling application of FIG. 2.

FIG. 6 is a flowchart of a method, in accordance with an example embodiment, for determining availability of the participants of a meeting scheduling program of an organization and generating invitations to the participants.

FIG. 7 is a flowchart of a method, in accordance with an example embodiment, for identifying and authenticating participants of a meeting scheduling program of an organization.

FIG. 8 is a flowchart of a method, in accordance with an example embodiment, for matching participants.

FIG. 9 is a flowchart of a method, in accordance with another example embodiment, for matching participants.

FIG. 10 is a block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments. It will be evident, however, to those skilled in the art that embodiments of the inventive subject matter may be practiced without these specific details. In general, well-known instruction instances, protocols, structures, and techniques have not been shown in detail.

In one embodiment, the system described in the present application includes a meeting scheduling application that helps employees of an organization or company stay in touch with existing colleagues or to meet new colleagues within the organization, by organizing a meeting, such as a lunch, a snack, a sports activity or any other such meetings. The system can send a meeting request using a mail client (such as Microsoft® Outlook) with the employee's availability to the meeting scheduling server. The system may also configure the employee's preferences in a client application accessed via a browser or an application in a mobile or client device. The meeting scheduling application in the meeting scheduling server then determines common time slots among colleagues in the employee's current network (e.g., other colleagues with whom the employee has already had lunch or meetings) or the meeting scheduling application will suggest an interesting new networking partner (e.g., a new colleague from the same organization). By connecting employees inside the organization to share knowledge, the system breaks up silo-thinking and helps build personal connections between people within the organization.

Example systems and methods to promote collaboration and communications among colleagues in an organization are described. In one example embodiment, a meeting scheduling system identifies participants of a networking program in the organization. The system determines the availability schedules of the participants of the networking program. For example. The networking program may be a lunch networking program. The availability schedules are selected by the corresponding participants. Participants are matched based on the corresponding availability schedules, location, and preferences. An invitation is generated to the matched participants.

In one embodiment, a first secure communication is established with a directory server of the organization to identify the participants in the organization. The directory server may be, for example, a Lightweight Directory Access Protocol (LDAP) server. In another embodiment, the director server may support Outlook Web Access accessed through EWS (Exchange Web Services) to identify participants and retrieve free/busy times automatically. A second secure communication is established with an email server of the organization to determine the availability schedules of the participants. The system may then identify and authenticate participants of the organization using the directory server and the mail server.

In one embodiment, the system generates a suggested recurring meeting time and place, such as a lunch time and place. The suggested recurring meeting time and place may be selected by a participant to be included in the corresponding participant's availability schedule. Recurring availabilities may be created by the users and are then stored in the system. Once a user creates an availability (e.g., by stating time, optional place and preferences), it will be stored in the system for future matching and the user will also receive a placeholder meeting request which reminds the user in his calendar.

In one embodiment, the system may receive a selection of available lunch times and places from a participant to be included in the corresponding participant's availability schedule via the mail server.

In one embodiment, the system may scan calendars of corresponding participants to identify their schedule availability.

In one embodiment, the system may present a list of possible people to meet to the user. The user can then directly select one of them to meet which will result in an instant match.

The system may also receive filter preferences from a participant. The filter preferences comprise a new colleague preference, an existing lunch colleague preference, an excluded colleague preference, a department preference, a location preference, and a keyword preference. The new colleague preference indicates a preference to include new colleagues for a meeting, such as, for example, a lunch meeting. The existing colleague preference may indicate a preference to include existing colleagues with whom the participant previously had a meeting, such as for example a lunch. The excluded colleague preference may indicate a preference to exclude identified colleagues from the meeting, such as for example lunch. The department preference can either exclude certain departments or reduce the probability of meeting colleagues from a similar department. The location preference indicates preferred places to meet. The keyword preference identifies colleagues associated with keywords.

FIG. 1A is a block diagram depicting an example environment 100 within which example embodiments may be deployed. The environment 100 may include one or more client machines (e.g., client machines 102, 104). For example, the client machines 102, 104 may be a personal computer, or a mobile computing device of employees of an organization such as in a company or a school.

In one embodiment, the client machine 102, 104 may be used to access emails and calendar information, and join a meeting scheduling program from the server machine 108. The client machine 102, 104 may execute a web browser (not shown) or a software application (not shown). For example, the web browser may be any browser commonly used to access a network of computers such as the World Wide Web. The web browser may load a user interface to access emails and calendar information from the server machine 108. In another embodiment, access may be performed by the server machine 108 where data retrieved from external systems is then stored on the server machine 108 and the clients can request this data.

The web browser may also be used to schedule a lunch meeting as part of the networking lunch program from the server machine 108. In another embodiment, the software application may load a user interface to access emails and calendar information from the server machine 108. In other words, the software application may include a dedicated mobile application for an operating system of the client machine 102, 104. In another embodiment, the server exposes a Representational State Transfer (REST) application programming interface (API) which can be accessed from any device.

The server machine 108 includes, for example, a meeting scheduling application 110, an email application 112, and an active directory application 114.

The email application 112 may be configured to provide the functionalities of a mail server such as, for example, a Simple Mail Transfer Protocol (SMTP) mail server. In other words, the mail server handles electronic message sent and received via a network of computers such as the Internet. A mail server also referred to as mail host or mail exchanger transfers electronic mail messages from one computer to another using a client-server application architecture. A message transfer agent (MTA) receives mail from either another message transfer agent, a mail submission agent (MSA), or a mail user agent (MUA). The transmission details are specified by the Simple Mail Transfer Protocol (SMTP) or Internet Message Access Protocol (IMAP). When a recipient mailbox of a message is not hosted locally, the message is relayed, that is, forwarded to another MTA. Every time an MTA receives an email message, it adds a “Received” trace header field to the top of the header of the message, thereby building a sequential record of MTAs handling the message. The process of choosing a target MTA for the next hop is also described in SMTP. In one embodiment, the email application 112 may provide other functionalities such as calendar information and address book information.

The active directory application 114 may be configured to provide the functionalities of a directory server such as, for example, a Lightweight Directory Access Protocol (LDAP) server. LDAP is an application protocol for accessing and maintaining distributed directory information services over an Internet Protocol (IP) network. Directory services may provide any organized set of records, often with a hierarchical structure, such as a corporate email directory. Similarly, a telephone directory is a list of subscribers with an address and a phone number. In one embodiment, the LDAP may be specific to the company and provide a directory information service for employees of the organization.

The meeting scheduling application 110 integrates with the email application 112 (e.g., Outlook® or Lotus®) and the active directory application 114. In one embodiment, the meeting scheduling application 110 securely communicate with the email application 112 and the active directory application 114 to match employees participating in the meeting scheduling program (a lunch networking program in an example embodiment) and to generate an invitation (a lunch invitation in an example embodiment) to the employees with matched schedules.

A federated identity may be used to enable the employee to access the meeting scheduling application 110 without having to log in again or to enable login to the meeting scheduling application 110 with the credentials of another company (e.g., Company X may configure their identity management so their employees do not have to log into the meeting scheduling application 110). The federated identity is a means of linking a person's electronic identity and attributes stored across multiple distinct identity management systems. One of the federated identity schemes includes single sign-on (SSO), in which a user's single authentication ticket or token, is trusted across multiple Information Technology (IT) systems or even organizations. SSO is a subset of federated identity management, as it relates to authentication and is understood on the level of technical interoperability. For example, SAP ID Service may be used as the default identity provider (IdP) used by SAP NetWeaver Cloud for Security Assertion Markup Language (SAML) 2.0 authentication. This protocol provides reliable standards-based authentication and single sign-on (SSO). The following illustrates an example of an address for the networking lunch application 110 to use SAP ID service for authentication:

SAP ID Service: https://help.netweaver.ondemand.com/default.htm?id_service.html#concept_{—}750685C6E4E44174971E7399D396D37B_{—}11

In another embodiment, the networking lunch application 110 may be configured to trust a custom IdP (intranet or portal). The following illustrates an example of an address using a custom identity provider: https://help.netweaver.ondemand.com/default.htm?using_identity_provider.html#concept_{—}0B49F10346C94249845EC16364FFF66D_{—}102

Those of ordinary skill in the art will recognize that other types of federated identity schemes may be used to allow the client machine 102 to log in once to access both the meeting scheduling application 110 and the email application 112.

The networking lunch application 110 may be configured to provide networking opportunities for employees of an organization by using meeting request functionalities provided by a mail client to easily integrate into an employee's daily routine of checking their emails. In one embodiment, the meeting scheduling application 110 receives a request from an employee to submit a placeholder which states when the employee is usually available (e.g., Fridays between 11:30 am and 1 pm at x campus location, or a default physical location based on the employee's employment position). In another embodiment, the meeting scheduling application 110 receives a single concrete meeting request with a specific colleague during a specified time. In yet another embodiment, the meeting scheduling application 110 receives a request from an employee to participate in a lunch program regularly scheduled on predetermined specific days. In yet another embodiment, the meeting scheduling application 110 does not receive any specific date or specific colleagues from the employee participating in the lunch program.

The meeting scheduling application 110 automatically sends out a meeting request to all participating colleagues for lunch, for example, one day before the scheduled lunch meeting. A matching algorithm may be used to create the best possible solution for all available timeslots, so that as many people as possible meet while fulfilling most constraints from each employee.

A participant may not be scheduled to meet another colleague unless both have entered overlapping availabilities. Also, especially in smaller organizations, there may only be a limited number of colleagues that are available at the same time as the participant. In order to maximize the number of colleagues that can be matched, the meeting scheduling application 110 may generate and identify specific days for the employees to participate in the networking lunch program. The dates for a corresponding location may be displayed to a participant in a dialog box.

In one embodiment, the meeting scheduling application 110 can automatically scan a participant's calendar by communicating with the email application 112 (e.g., via an API). If the meeting scheduling application 110 finds that a participant has no meetings and is in the office during a certain time, for example, between 11:30 am until 1:30 pm on Monday, the meeting scheduling application 110 may automatically create availability for the participant. For example, the meeting scheduling application 110 may scan the calendar of the participant to detect if the participant is out of the office. If so, the participant's existing availabilities will be ignored.

In another embodiment, the participants of the networking lunch program may not be limited to the organization but may include members from a group or people affiliated with an organization. Furthermore, the networking lunch program may not only be tailored to a specific group within an organization but may also be customized to include other groups in addition to the employees of the organization. For example, a company may wish to have its employees collaborate and exchange ideas over lunch with employees from a subsidiary organization or from another organization having a collaborative agreement.

The client machines 102, 104, and the server machine 108 may be coupled to each other via a network 106. The network 106 enables communication between systems. Accordingly, the network 106 may be a mobile telephone network, a Plain Old Telephone (POTS) network, a wired network, a wireless network (e.g., a WiFi or WiMax network), or any suitable combination thereof. The communication may be based on any communication protocols. Examples of communication protocols include Transmission Control Protocol/Internet Protocol (TCP/IP), HyperText Transfer Protocol (HTTP), File Transfer Protocol (FTP), Simple Mail Transfer Protocol (SMTP), Post Office Protocol (POP), Internet Message Access Protocol (IMAP), Wireless Access Protocol (WAP), Gopher, wireless internet protocols, and instant messaging protocols. The network 106 may be implemented using the Internet, a wide area network (WAN), a local area network (LAN), or any suitable combination thereof.

FIG. 1B is a block diagram depicting another example environment 101 within which example embodiments may be deployed. The environment 101 includes client machines 102, 104 communicating with a mail server machine 113, an active directory server machine 115, and a networking lunch server machine 109 via the network 106.

In contrast to FIG. 1A, the meeting scheduling server machine 109 is separate from the mail server machine 113 and the active directory server machine 115. The meeting scheduling server machine 109 may communicate with the mail server machine 113 and the active directory server machine 115 via the network 106. The meeting scheduling server machine 109 may include the networking lunch application 110 (i.e. a meeting scheduling application) and a storage device 116. For example, the storage device 116 may store the availability schedule of the participants, a log of lunch meetings of the participants, preferences, authentication information, and other data generated by the networking lunch application 110, mail server machine 113, and active directory server machine 115. In another embodiment, the storage device 116 is external to the meeting scheduling server machine 109.

Those of ordinary skills in the art will recognize that the systems illustrated in FIG. 1A and FIG. 1B may be configured using other variations where a module or application, such as the meeting scheduling application 110 or the storage device 116, may reside in a different or in the same machine.

FIG. 2 is a block diagram illustrating an example embodiment of the meeting scheduling application. The meeting scheduling application 110 includes an identity management module 202, a schedule module 204, a filter preferences module 206, a configuration module 208, a calendar scanner module 210, a matching module 212, and an invitation module 214.

The identity management module 202 may establish a first secure communication with a directory server of the organization, such as the active directory server machine 115 of FIG. 1B, to identify the participants in the organization. The active directory server machine 115 may reside behind a firewall of the organization. As such, the first secure communication may be established using various authentication means, such as for example, a username and a password, or an authentication token. The identity management module 202 may prohibits any access to the networking lunch server machine 109 without proper credentials. The networking lunch server machine 109 does not use an identity management to access other external systems like mail or calendar scanner but may be a service user stated in the configuration.

The identity management module 202 may also establish a second secure communication with an email server of the organization, such as the mail server machine 113 of FIG. 1B, to determine the availability schedules of the participants. Similarly, the mail server machine 113 may reside behind a firewall of the organization. The second secure communication may be established using various authentication means, such as for example, a username and a password, or an authentication token.

The identity management module 202 may, thus, identify and authenticate a participant of the organization using information from the directory server and the mail server. FIG. 3 illustrates an example of the identity management module 202 that includes a single sign on module 302 and a custom id provider module 304. As previously described, the single sign one module 302 enables a single sign on authentication scheme to enable a user to access the meeting scheduling application 110 without having to log in again after having logged in the mail server. In other words, once the user has logged in and been authenticated by the mail server, the user may also access the meeting scheduling application 110 without having to log in again in a session. The custom id provider module 304 enables a user to access the meeting scheduling application 110 using an authentication scheme of another custom id provider.

The schedule module 204 may determine availability schedules of participants of the networking program (such as, for example, a lunch networking program). The availability schedules are selected by the corresponding participants. FIG. 4 illustrates an example embodiment of a schedule module 204. For example, the schedule module 204 includes a suggested regularly scheduled meeting module 402, a custom meeting availability module 404, and a no-time specified module 406.

The suggested regularly scheduled meeting module 402 generates a suggested recurring meeting time and place for a participant of the networking program. For example, a time and place may be preselected (e.g., every first Friday of the month at noon at Cafeteria building one). The schedule module 204 may receive the participant's choice of the suggested recurring meeting time and place to be included in his or her availability schedule. The suggested recurring meeting time and place may also be referred to as “Event Days.”

The custom meeting availability module 404 receives a selection of available meeting time and places from a participant to be included in the corresponding participant's availability schedule, for example, via the mail server machine 113. The participant may actively select or put aside a time in their schedule to participate in the networking program. For example, the participant may identify a time slot in their schedule, such as every Monday from 12 pm to 1 pm. Optionally, the participant may also identify a meeting location.

The no-time specified schedule module 406 is enabled when no selection of specific time availability is received from a participant. In that case, the no-time specified schedule module 404 may scan the calendar of the participant to identify his or her availability to join the networking program. For example, the no-time specified schedule module 406 may scan the calendar of the participant and determine that the participant is in the office and does not have any meetings on Monday and Friday between the hours of 12 pm and 1 pm. As such, the no-time specified schedule module 406 may use those identified times to match with other participants of the networking program.

The filter preferences module 206 may be configured to receive filter preferences from a participant of the networking program. FIG. 5 illustrates an example embodiment of the filter preferences module 206. The filter preferences module 206 may include a new colleagues module 502, an existing colleagues module 504, an excluded colleagues module 508, and a keywords module 506 (e.g., keywords may include department ID and location ID).

The random colleague module 502 may include a filter setting to indicate a preference to include new colleagues for a meeting. For example, this particular setting may be useful for a new employee of the organization to be introduced to other colleagues within the organization.

The existing colleague module 504 may include a filter setting to indicate a preference to include existing colleagues with whom the participant previously had a meeting. This particular setting may be useful when a participant wishes to limit his meetings with known colleagues. This filter setting may also be referred to as “buddies list.” In another embodiment, the participant may also identify a subset of existing colleagues with whom the participant previously had a meeting. A “history” function may show all past networking meeting of a user in the user interface.

The excluded colleague module 508 may include a filter setting to indicate a preference to exclude identified colleagues from a meeting. This filter setting may be used when a participant wishes to exclude certain colleagues identified by the participant.

The tags module 506 may include a keywords preference to identify colleagues associated with keywords. For example, tags associated with each participant may be stored in the storage device 116. The tags may relate to interests, topics, titles, positions, departments, and so forth. For example, the participant may specify in the keywords module 506 that he or she wishes to have a meeting with colleagues who share a common department or interest. In one embodiment, upon signing up for the networking program, the participant may be asked to identify keywords to be associated with the participant. For example, a participant who plays a certain musical instrument may wish to tag the name of the musical instrument to his or her name. In another embodiment, the participant may be presented with the most popular keywords to select from.

The configuration module 208 may be used to further define preferences of the participant. For example, the participant may identify his or her favorite lunch location or cafeterias. The participant may further identify whether he or she is interested in meeting new colleagues with the same gender only, receive reminders, or define a matching time period. For example, the participant may wish to be matched as early as one day and as late as 90 minutes before the meeting time. The configuration module 208 may further have an option to not repeat a networking activity with the same participant within X number of days.

The calendar scanner module 210 scans the respective schedules of the participants to find matching availability based on the schedule availabilities as determined by the schedule module 204, filter preferences as identified in filter preferences module 206, and configurations as described in configuration module 208. In one embodiment, the calendar scanner module 210 accesses the schedule of the participants by communicating with the email application 112 of FIG. 1A, or the mail server machine 113 of FIG. 1B.

The matching module 212 uses a matching algorithm to create the best possible solution for all available timeslots so that as many participants as possible can meet.

The invitation module 214 generates an invitation to the matched participants. For example, the meeting scheduling application 110 may be associated with its own mail account in an organization (e.g., networking@company.com). Participants of the networking program may receive notification mails and calendar appointments via their mail account. Participants also can use their mail account to enter their availability by sending meeting request from their accounts to the networking application email address.

FIG. 6 is a flowchart of a method 600, in accordance with an example embodiment, for determining availability of the participants of a networking program of an organization and generating invitations to the participants. At operation 602, the system determines availability schedules of the participants of a networking program. The availability schedules are selected by the corresponding participants in an organization. At operation 604, the system matches the participants based on the corresponding availability schedules and location of the participants. At operation 606, the system generates an invitation to the matched participants.

FIG. 7 is a flowchart of a method 700, in accordance with an example embodiment, for identifying and authenticating participants of a networking program of an organization. At operation 702, a server establishes a first secure communication with a directory server of the organization to identify the participants in the organization. At operation 704, the server establishes a second secure communication with a mail server of the organization to determine the availability schedules of the participants. At operation 706, the server identifies and authenticates a participant of the networking program of the organization using the directory server and the mail server.

FIG. 8 is a flowchart of a method 800, in accordance with an example embodiment, for matching participants of a networking program of an organization. At operation 802, a server generates a suggested meeting time and place (may be optionally recurring at the same time or same place) and receives a selection of the suggested recurring meeting time and place from a participant to be included in the corresponding participant's availability schedule. At operation 804, the server receives filter preferences from the participants. At operation 806, the server matches the participants based on the selected availability and filter preferences.

FIG. 9 is a flowchart of a method 900, in accordance with another example embodiment, for matching participants of a networking program of an organization. At operation 902, the server scans calendars of corresponding participants of the networking program to determine their availability schedule. At operation 904, the server receives filter preferences from the participants of the networking program. At operation 906, the server matches the participants based on the selected availability and filter preferences.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

With reference to FIG. 10, an example embodiment extends to a machine in the example form of a computer system 1000 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 may include a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). In example embodiments, the computer system 1000 also includes one or more of an alpha-numeric input device 1012 (e.g., a keyboard), a user interface (UI) navigation device or cursor control device 1014 (e.g., a mouse), a disk drive unit 1016, a signal generation device 1018 (e.g., a speaker), and a network interface device 1020.

The disk drive unit 1016 includes a machine-readable storage medium 1022 on which is stored one or more sets of instructions 1024 and data structures (e.g., software instructions) embodying or used by any one or more of the methodologies or functions described herein. The instructions 1024 may also reside, completely or at least partially, within the main memory 1004 or within the processor 1002 during execution thereof by the computer system 1000, the main memory 1004 and the processor 1002 also constituting machine-readable media.

While the machine-readable storage medium 1022 is shown in an exemplary embodiment to be a single medium, the term “machine-readable storage medium” may include a single storage medium or multiple media (e.g., a centralized or distributed database, or associated caches and servers) that store the one or more instructions 1024. The term “machine-readable storage medium” shall also be taken to include any tangible medium that is capable of storing, encoding, or carrying instructions 1024 for execution by the machine and that causes the machine to perform any one or more of the methodologies of embodiments of the present description, or that is capable of storing, encoding, or carrying data structures used by or associated with such instructions 1024. The term “machine-readable storage medium” shall accordingly be taken to include, but not be limited to, solid-state memories, optical and magnetic media, and non-transitory machine-readable storage media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

It should be noted that various modifications and changes may be made to these example embodiments without departing from the broader spirit and scope of the present invention.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within the scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within the scope of various embodiments. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of the example embodiments as represented by the appended claims. The specification and drawings are, accordingly, to be regarded in an illustrative rather than a restrictive sense.

What is claimed is:

1. A computer-implemented method comprising:
determining, using at least one processor of a machine, availability schedules of participants of a meeting scheduling program, the availability schedules selected by the corresponding participants in an organization;
matching a plurality of participants based on the corresponding availability schedules and location of the participants; and
generating an invitation to the matched plurality of participants.

2. The computer-implemented method of claim 1, further comprising:
establishing a first communication with a directory server of the organization to identify the participants in the organization;
establishing a second communication with an email server of the organization to determine the availability schedules of the participants; and
identifying and authenticating a participant of the organization using the directory server and the mail server.

3. The computer-implemented method of claim 1, further comprising:
generating a suggested recurring meeting time and place; and
receiving a selection of the suggested recurring meeting time and place from a participant to be included in the corresponding participant's availability schedule.

4. The computer-implemented method of claim 1, further comprising:
receiving a selection of available meeting times and places from a participant to be included in the corresponding participant's availability schedule via a mail server; and
scanning calendars of corresponding participants to identify availability.

5. The computer-implemented method of claim 1, wherein the meeting is for lunch.

6. The computer-implemented method of claim 5, further comprising:
receiving filter preferences from a participant, the filter preferences comprising a new colleague preference, an existing lunch colleague preference, an excluded colleague preference, and a keyword preference,
the new colleague preference indicating a preference to include new colleagues for lunch, the existing lunch colleague preference indicating a preference to include existing colleagues with whom the participant previously had lunch or prefer to have lunch with, the excluded colleague preference indicating a preference to exclude identified colleagues from lunch, and the keyword preference to identify colleagues associated with keywords.

7. The computer-implemented method of claim 1, further comprising:
receiving a request to participate in the meeting program of the organization from a first participant and a second participant.

8. The computer-implemented method of claim 7, further comprising:
generating a meeting scheduling invitation to the first and second participants with matching meeting scheduling program availability schedules and a physical location within the organization of the first and second participants;
receiving a confirmation accepting the meeting invitation from the first and second participants; and
scheduling a meeting in the corresponding calendar of the first and second participants in a mail server in response to receiving the confirmation.

9. The computer-implemented method of claim 8, further comprising:
receiving confirmation of the meeting from the first and second participants;
storing a name of the first participant in an existing colleague preference of the second participant; and
storing a name of the second participant in an existing colleague preference of the first participant,
wherein the existing colleague preference indicates a preference to include existing colleagues with whom the participant previously had meetings.

10. The computer-implemented method of claim 8, further comprising:
matching a plurality of participants to maximize cross-collaboration between participants from different departments of an organization.

11. A server comprising:
a storage device; and
a processor comprising a schedule module, a matching module, and an invitation module,
the schedule module configured to determine availability schedules of participants of a meeting scheduling program, the availability schedules selected by the corresponding participants in an organization,
the matching module configured to match a plurality of participants based on the corresponding availability schedules and location of the participants,
the invitation module configured to generate an invitation to the matched plurality of participants.

12. The server of claim 11, wherein the processor further comprises:
an identity management module configured to establish a first communication with a directory server of the organization to identify the participants in the organization, to establish a second communication with an email server of the organization to determine the availability schedules of the participants, and to identify and authenticate a participant of the organization using the directory server and the mail server.

13. The server of claim 11, wherein the schedule module further comprises:
a suggested regularly scheduled meeting module configured to generate a suggested recurring meeting time and place, and to receive a selection of the suggested recurring meeting time and place from a participant to be included in the corresponding participant's availability schedule.

14. The server of claim 11, wherein the schedule module further comprises:
a custom meeting availability module configured to receive a selection of available meeting times and places from a participant to be included in the corresponding participant's availability schedule via a mail server; and
a no time specified module configured to scan calendars of corresponding participants to identify availability.

15. The server of claim 11, wherein the meeting is for lunch.

16. The server of claim 15, wherein the processor further comprises:
a filter preferences module configured to receive filter preferences from a participant, the filter preferences comprising a new colleague preference, an existing lunch colleague preference, an excluded colleague preference, and a keyword preference,
the new colleague preference indicating a preference to include new colleagues for lunch, the existing lunch colleague preference indicating a preference to include existing colleagues with whom the participant previously had lunch or prefer to have lunch with, the excluded colleague preference indicating a preference to exclude identified colleagues from lunch, and the keyword preference to identify colleagues associated with keywords.

17. The server of claim 11, wherein the processor further comprises:
a schedule module configured to receive a request to participate in the meeting scheduling program of the organization from a first participant and a second participant;
an invitation module configured to generate a meeting scheduling invitation to the first and second participants with matching meeting scheduling program availability schedules and a physical location within the organization of the first and second participants, and to receive a confirmation accepting the meeting invitation from the first and second participants; and
the schedule module configured to schedule a meeting in a corresponding calendar of the first and second participants in a mail server in response to receiving the confirmation.

18. The server of claim 17, wherein the invitation module is configured to receive confirmation of the meeting from the first and second participants, to store a name of the first participant in an existing colleague preference of the second participant in the storage device, to store the name of the second participant in an existing colleague preference of the first participant in the storage device, wherein the existing colleague preference indicates a preference to include existing colleagues with whom the participant previously had meetings.

19. The server of claim 18, wherein the matching module is configured to match a plurality of participants to maximize cross-collaboration between participants from different departments of the organization.

20. A non-transitory machine-readable storage medium storing instructions which, when executed by at least one processor, performs operations comprising:
determining availability schedules of participants of a meeting scheduling program, the availability schedules selected by the corresponding participants in an organization;
matching a plurality of participants based on the corresponding availability schedules and location of the participants; and
generating an invitation to the matched plurality of participants.
